(19) United States
(12) Patent Application Publication
(10) Pub. No.: US 2024/0208808 A1
(43) Pub. Date: Jun. 27, 2024

(54) Method for Production of Blue Ammonia

(71) Applicant: TOPSOE A/S, Kgs. Lyngby (DK)

(72) Inventors: Ameet KAKOTI, Kokkedal (DK); Per Juul DAHL, Vedbaek (DK)

(73) Assignee: TOPSOE A/S, Kgs. Lyngby (DK)

(21) Appl. No.: 18/555,519

(22) PCT Filed: Apr. 6, 2022
(86) PCT No.: PCT/EP22/59091

§ 371 Date: Oct. 14, 2023

(30) Foreign Application Priority Data
Apr. 28, 2021 (EP) 21170905.0

(51) Int. Cl. C01B 3/02; C01B 3/38; C01C 1/04

(52) U.S. Cl. CPC C01B 3/025; C01B 3/382; C01C 1/0405; C01B 2203/0233; C01B 2203/0475; C01B 2203/0485; C01B 2203/068; C01B 2203/146

(57) ABSTRACT

The present invention provides a method and system for producing blue ammonia, providing for a higher percentage of carbon capture. The method and system of the invention may be used in any ammonia plant.

### FIELD OF INVENTION

The present invention provides a method and system for producing blue ammonia, providing for a higher percentage of carbon capture. The method and system of the invention may be used in any ammonia plant.

### BACKGROUND ART

Blue ammonia is a fossil fuel-based product produced with minimum emission of CO₂ to the atmosphere. It is seen as a transition product between conventional fossil fuel-based ammonia and green ammonia produced from green or renewable power and air. The CO₂ resulting from a blue ammonia production shall be stored permanently or converted into other chemicals. The main steps for producing blue ammonia are essentially the same as for producing conventional fossil fuel-based ammonia, the difference being that more of the carbon stemming from the carbon fuel is captured, providing a possibility for further processing.

The key here is that the blue ammonia does not release any carbon dioxide when used as fertilizer or burned. Currently available technology traps nearly all CO₂ generated during the conversion process making this fuel one of the first carbon free fuel options for mass use. Blue ammonia is considered an environmental friendly product which can be used until sufficient renewable or green power is available for producing green ammonia.

If we can continue to diversify our power generation methods and create more and more renewable or green energy, the potential rises that we can perfect a method of green energy that produces hydrogen and ammonia as byproducts giving us a completely clean and safe power cycle.

Document WO2018/149641 discloses a process for the synthesis of ammonia from natural gas comprising conversion of a charge of desulphurized natural gas and steam, with oxygen-enriched air or oxygen, into a synthesis gas (11), and treatment of the synthesis gas (11) with shift reaction and decarbonation, wherein a part of the CO₂-depleted synthesis gas, obtained after decarbonation, is separated and used as fuel fraction for one or more furnaces of the conversion section, and the remaining part of the gas is used to produce ammonia.

The present invention is different from the setup disclosed in that document in that the present invention recovers a flash gas from the CO₂ removal step and enables the use of a more carbon depleted fuel, thereby achieving a higher carbon recovery (more than 99%) compared to the cited document.

### SUMMARY OF INVENTION

The present invention refers to a method, system and plant for producing ammonia with a high percentage of carbon capture, preferably >99% of carbon capture, when compared to the standard method where optimally between about 90-93% of carbon capture is achieved.

The method of the present invention provides for the following advantages:
Can be applied for grass root plants and as revamps
Utilize the already available CO₂ removal step in the ammonia process to perform the complete CO₂ capture;
Enables >99% CO₂ recovery;
Reduces the adiabatic flame temperature thus reducing the NOx formations and thereby the NOx emission to the atmosphere;

Said advantages are provided by a set of features, comprising:
Natural gas firing is reduced to be used for pilot burners;
Carbon depleted gases mainly H₂ and N₂ used as fuel for the fuel systems;
Off-gases containing more than 60% Methane and/or CO are redirected to the reforming section or to the desulfurization section as additional feed gas;

### BRIEF DESCRIPTION OF DRAWINGS

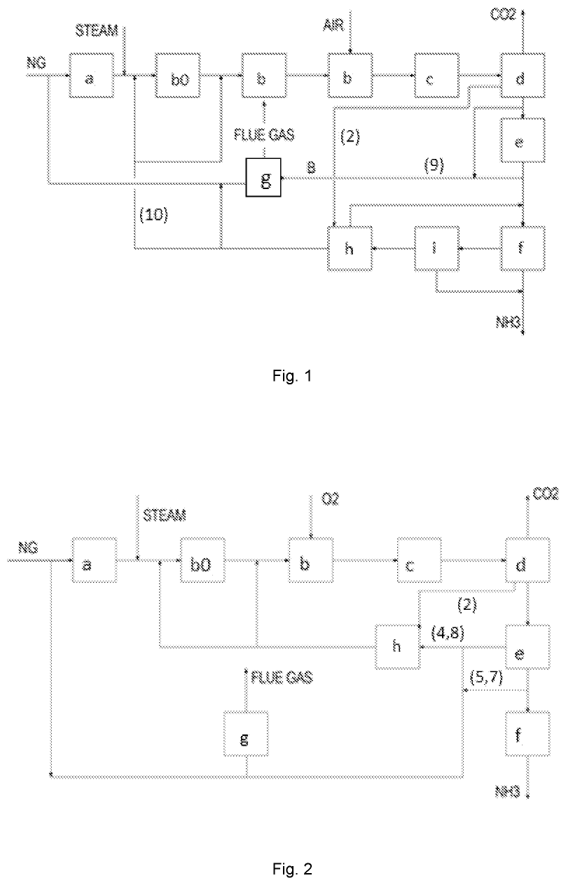

FIG. 1 shows an overview for producing ammonia according to a state of the art method.
a) Desulphurization
b₀) Pre-reforming
b) Reforming (SMR)
b) Secondary reformer (air blown ATR)
c) Shift section
d) CO₂ removal section
e) Methanation
f) Ammonia synthesis
g) Fuel system(s)
h) Off gas recycle compressor
i) Ammonia recovery
Stream (10). Recycle off-gas stream
Stream (9). Hydrogen rich fuel comprising nitrogen (replacing use of natural gas as fuel)
Stream (2) Flash gas from CO₂ removal

FIG. 2 shows an overview of a method to produce Ammonia using Topsoe SynCOR Ammonia™ process”:
a) Desulphurization
b₀) Pre-reforming
b) Reforming (ATR)
c) Shift section
d) CO2 Removal
e) Nitrogen wash or PSA
f) Ammonia synthesis
h) Off gas recycle compressor
g) Fuel system(s)
Stream (4,8). Recycle off-gas stream.
Stream (5,7). Hydrogen rich fuel comprising nitrogen (replacing use of natural gas as fuel)
Stream 2. Flash gas from CO₂ removal

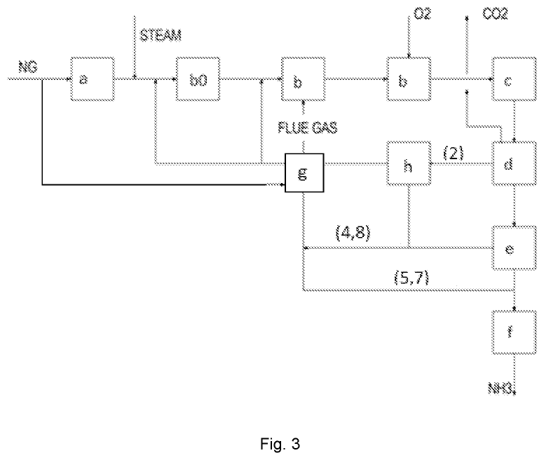

FIG. 3 shows an overview for producing ammonia using a steam reformer followed by an autothermal reformer in the synthesis gas generation:
a) Desulphurization
b₀) Pre-reforming
b) Reforming (SMR)
b) Reforming (ATR)
c) Shift section
d) CO₂ removal
e) Nitrogen wash or PSA
f) Ammonia synthesis
h) Off gas recycle compressor
g) Fuel system(s)
Stream (4,8). Recycle off-gas stream.
Stream (5,7). Hydrogen rich fuel comprising nitrogen (replacing use of natural gas as fuel)
Stream (2). Flash gas from CO₂ removal

References used to represent the different steps of in the method of the present invention are:
a) Desulphurization
b₀) Pre-reforming
b) Reforming (SMR)
b) Reforming (ATR)
b) Reforming (Air blown secondary reformer)
c) Shift
d) CO₂ Removal
e) Nitrogen wash or PSA or Methanation
f) Ammonia synthesis
g) Fuel system(s)
h) Off gas recycle compression
i) Ammonia recovery
Stream (4,8,10): Recycle off-gas stream.
Stream (9): Hydrogen rich fuel (replacing use of natural gas as fuel)
Stream (5,7): Hydrogen rich fuel (replacing use of natural gas as fuel)
Stream (2): Flash gas from CO₂ removal

### Definitions

Blue Ammonia is ammonia that is created from using fossil fuel where at least 90% of the Carbon in the fossil fuel is captured to be used in other products and processes or to be stored.

Catalyst poison means a substance that reduces the effectiveness of a catalyst in a chemical reaction. In theory, because catalysts are not consumed in chemical reactions, they can be used repeatedly over an indefinite period of time. In practice, however, poisons, which come from the reacting substances or products of the reaction itself, accumulate on the surface of solid catalysts and cause their effectiveness to decrease. For this reason, when the effectiveness of a catalyst has reached a certain low level, steps are taken to remove the poison or replenish the active catalyst component that may have reacted with the poison. Commonly encountered poisons include carbon on the silica-alumina catalyst in the cracking of petroleum; sulfur, arsenic, or lead on metal catalysts in hydrogenation or dehydrogenation reactions; and oxygen and water on iron catalysts used in ammonia synthesis.

Contaminant means any substances or elements which are not desirable. Within the context of the present invention, contaminants comprise catalyst poisons.

Flash gas means an intermediate gas stream obtained during desorption of CO₂ in a solvent based CO₂ removal step.

Green Ammonia is ammonia that is produced by using green electricity, water and air.

Green Electricity is electricity produced from renewable resources such as wind, solar, Hydro or geothermal energy

Ammonia synthesis catalysts mean, within the context of the present invention, any catalysts suitable for synthesizing ammonia and also suitable for cracking ammonia. These catalysts are preferably iron (Fe) based, but may also comprise other catalysts suitable for the same purpose and operating at similar conditions.

Electrolysis of water means decomposition of water into oxygen and hydrogen gas due to the passage of an electric current.

Fuel systems comprise fuel systems for supply of fuel to the combustion side of tubular reformers and/or fired heaters and/or auxiliary boilers and/or gas turbines. These systems comprise one or more burners in which the incoming fuel streams are burned together with air at variable temperature and pressure.

High-pressure electrolysis (HPE) is the electrolysis of water by decomposition of water (H₂O) into oxygen (O₂) and hydrogen gas (H₂) due to the passing of an electric current through the water at elevated pressure, typically above 10 bar.

Make-up ammonia or Traded Ammonia comprises ammonia (NH₃) and water (H₂O), preferably between 0.2 to 0.5% of water content. It is usually supplied as a liquid but may also be a solution comprising different physical states. The effect of water comprised in ammonia feedstock in the ammonia decomposition process is primarily that due to poisoning the process, which usually has to take place at a high temperatures. This will increase process cost for ammonia decomposition as well as cost of construction materials in the plant. According to National Bureau of Standards ammonia shall conform to the following properties: minimum purity of 99.98% (wt), maximum 0,0005% (wt) oil and maximum 0.02% (wt) moisture.

Nitridation means the formation of nitrogen compounds through the action of ammonia.

PSA means pressure swing adsorption.

Shift means Water-gas shift reaction (WGSR) or Shift reaction, the reaction of carbon monoxide and water vapor to form carbon dioxide and hydrogen:

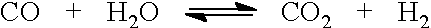

The WGSR is an important industrial reaction that is used in the manufacture of ammonia, hydrocarbons, methanol, and hydrogen. It is also often used in conjunction with steam reforming of methane and other hydrocarbons. In the Fischer-Tropsch process, the WGSR is one of the most important reactions used to balance the H₂/CO ratio. The water gas shift reaction is a moderately exothermic reversible reaction. Therefore, with increasing temperature the reaction rate increases but the carbon dioxide production becomes less favorable. Due to its exothermic nature, high carbon monoxide percentage is thermodynamically favored at low temperatures. Despite the thermodynamic favorability at low temperatures, the reaction is faster at high temperatures.

Shift unit or section means a process step where the shift reaction is performed.

### DESCRIPTION OF THE INVENTION

Reducing CO₂ emission has become a bound task in the chemical industry. Production of ammonia using hydrocarbons as feedstock inevitably results in CO₂ formation which typically ends up in at least two CO₂ containing process streams, one almost pure CO₂ stream (1) extracted from the syngas cleaning section and one or more flue gas streams (2). The CO₂ stream (1) can be utilized for further chemical processing or stored. The CO₂ in the flue gas stream (2) needs to be recovered before it can find similar use. The flue gas recovery process has a high operating and capital cost. It is therefore an advantage to limit the CO₂ content in the flue gas.

It is well known that CO₂ in the flue gas can be avoided by using carbon free fuels. In general hydrocarbons such as natural gas and carbon containing off gases originating from the process are used as fuels. The advantage of this invention is that the main part of these fuels are replaced by an internal hydrogen rich stream and that the unavoidable off gas are recycled to the process. By applying this invention it is possible to reduce the CO₂ content in the flue gas streams by more than 90%. Provided the pure CO₂ stream (1) is utilized or stored, then the product ammonia will be considered to be blue.

### Example 1

Table 1 shows the benefits of the proposed layout in the present invention, in terms of carbon recovery (%).

Traditional ammonia production involves utilization of off gases from ammonia recovery and syngas preparation steps to supplement natural gas as main fuels for fired heater/process furnaces. This would result in carbon emissions from flue gas stack which could partly be recovered by using a solution based carbon capture technology. The recovery rate for such a plant, including carbon recovery from flue gases would not be higher than 90% and is a capital intensive process. With the proposed layout including firing of hydrogen rich fuel and utilization of off gases in the main process results in significant carbon emission reduction, more than 99% recovery. This process will be significantly cheaper and would require minimum steps and will have lower footprint on plot.

TABLE 1

| | Syncor Ammonia | Proposed layout: |
|---|---|---|
| | (existing process) | Blue Ammonia |
| Ammonia production, MTPD | 3500 | 3500 |
| CO₂ in Flue gas, Nm³/h | 26,205 | 1160 |
| CO₂ as 100%, captured for | 97,995 | 131,448 |
| storage/utilization, Nm³/h | | |
| Carbon recovery, %, approx | 80% | >99% |

### Preferred Embodiments

1. Process for producing ammonia comprising the steps of:
a) Removing sulphur and other contaminants from a hydrocarbon feed;
b) Reforming the hydrocarbon stream from step a) and obtaining synthesis gas comprising CO, CO₂, H₂, H₂O and CH₄;
c) Sending the gas from step b) through a shift reaction step reducing the CO content;
d) Sending the gas from step c) to a CO₂ removal step where it is split in at least 2 streams: (1) a CO₂ rich stream, and (3) a hydrogen rich stream;
e) Sending the hydrogen rich stream (3) from step d) through:
i) hydrogen purification and nitrogen wash, where H₂O, CO, CO₂, CH₄ are removed in an off-gas stream (4) and N₂ is added to obtain a synthesis gas stream (5) comprising N₂ and H₂; or ii) a PSA, resulting in a hydrogen stream (6) containing more than 99.5% hydrogen to which nitrogen is added to obtain a synthesis gas stream (7) comprising N₂ and H₂ and an off-gas stream (8); or
iii) methanation, converting the CO and CO₂ together with H₂ into CH₄ and H₂O, to obtain a synthesis gas stream (9), comprising N₂, H₂ and inerts, comprising CH₄;
f) Sending a part of the synthesis gas stream (5,7,9) from step e) through an ammonia synthesis section, where it is converted to NH₃ and another part of the synthesis gas stream (5,7,9) is sent to the fuel systems,

Wherein at least part of the off-gas (4,8) removed in step e) i) and e) ii) or at least part of recovered CH₄ (10) stemming from synthesis gas in step e) iii) are compressed and sent to step a) or b).
1.1 The reformer used in step b) is preferably an autothermal reformer (ATR) but may be any other suitable reformer.
1.2 The gas from step b) is subject to shift reaction wherein the CO content is preferably reduced to below 4%.

The shift reaction in step c) is CO+H₂O=CO₂+H₂.
1.3 The CO₂ rich stream (1) obtained in step d) preferably contains more than 97% of CO₂ and can be stored or used for production of other chemicals, such as urea.
1.4 The hydrogen rich stream (3) obtained in step d) preferably contains more than 93% H₂ on dry basis.
2. Process according to embodiment 1 wherein the reforming step b) is operated in an autothermal reformer or in a tubular reformer, followed by a step in an autothermal reformer or in a tubular reformer and followed by a step in an air blown secondary reformer.

A tubular reformer is also known as a steam reformer.
3. Process according to any one of the preceding embodiments wherein in step d) the gas from step c) is sent to a CO₂ removal step where it is split in 3 streams: (1) a CO₂ rich stream, (2) flash gas and (3) a hydrogen rich stream and wherein the flash gas is compressed together with the streams (4,8,10) and sent to step a) or b).
4. Process according to any one of the preceding embodiments wherein a hydrocarbon fuel, flash gas (2) from step d), off-gas (4,8) from step e) and part of the synthesis gas streams (5,7,9) from step e) are either premixed or fed separately to the fuel systems.
5. Process according to any of the preceding embodiments comprising an adiabatic pre-reforming step b₀) of the hydrocarbon stream from step a), before step b), wherein a synthesis gas comprising CH₄, CO, CO₂, H₂ and H₂O is obtained.
6. Process according to any one of the preceding embodiments wherein step e) is performed by sending the hydrogen rich stream (3) from step d) through a drier unit removing CO₂ and H₂O to an acceptable level before sending it to a nitrogen wash unit where an off-gas stream (4) is removed and at least part of it is sent to the fuel system g), and nitrogen is added.
7. Process according to any one of the preceding embodiments wherein in step e) i) the hydrogen purification and nitrogen addition are performed by sending the hydrogen rich stream (3) to a PSA, then nitrogen is added to the resulting hydrogen stream and at least part of the resulting off-gas stream (8) is sent to the fuel system g).
8. Process according to any one of the preceding embodiments wherein in the methanation step e) iii) CO, CO₂ and hydrogen are converted to CH₄+H₂O, wherein a purge gas stream, comprising this CH₄ from the ammonia synthesis, is required wherein at least part of the CH₄ in the purge gas from the ammonia synthesis section is sent as feed to the reforming step b).
9. Process according to embodiment 8, wherein the CH₄ is captured from a stream of non-reacted components from the ammonia synthesis section in a hydrogen recovery unit resulting in a stream containing more than 99% hydrogen, which is sent to the ammonia synthesis section f) and/or the fuel system g), and an off-gas containing more than 95% of the CH₄ content in the synthesis gas stream into the ammonia synthesis section f), which is sent to the reforming step b) and/or the fuel system g).
10. Process according to embodiment 8, wherein the amount of air to the air blown secondary reformer is adjusted to obtain a specific ratio of N₂ and H₂ between 1 to 2.5 and 1 to 3.5, in the stream from the methanation reactor.
11. Process according to embodiment 10 wherein the synthesis gas stream obtained from step e) comprises N₂ and H₂ in a ratio of 1 to between 2.9 and 3.1.
12. Process according to embodiment 10 wherein the stream obtained from step e) comprises N₂ and H₂ in a ratio of 1 to 3.0.
13. Process according to any one of the preceding embodiments wherein the hydrogen rich stream (3) from step d) is sent through a methanation reactor converting CO, CO₂ and H₂ to CH₄ and H₂O and sending a first part of the product stream to step f) and a second part of the product stream as fuel, for preheating the streams to step a, b and c, and for fuel required in the fuel systems g).
14. System for producing ammonia according to the process in embodiments 1 to 13, comprising:
a) a desulfurization unit;
b) a reforming unit;
c) a shift unit;
d) a CO₂ removal unit;
e) a nitrogen washing unit or a pressure swing adsorption unit or a methanation unit,
f) an ammonia synthesis section; and
g) fuel systems,
wherein streams (5,7,9) are directed to fuel systems g) and wherein streams (4,8,10) are directed to desulfurization unit a) and/or to reforming unit b).
15. System for producing ammonia according to embodiment 14, wherein the carbon content in the combined flue gases from the fuel systems is less than 5%, preferably less than 1% of the combined carbon content in the hydrocarbon feed and the hydrocarbon fuel.
16. System according to any one of the preceding embodiments wherein a further pre-reforming unit b₀) is upstream to the reforming unit b).
17. System according to any one of the preceding embodiments wherein the reforming unit b) comprises an autothermal reformer or a tubular reformer followed by an autothermal reformer or a tubular reformer followed by an air blown secondary reformer.
18. System according to embodiment 17 wherein the reforming unit comprises an autothermal reformer and the CO₂ removal unit d) is a CO₂ and H₂O drier followed by a nitrogen wash.
19. System according to embodiment 17 wherein the reforming unit b) comprises an autothermal reformer and the CO₂ removal unit d) is a PSA.
20. System according to embodiment 17 wherein the reforming unit b) comprises a tubular or steam reformer followed by an autothermal reformer and the CO₂ removal unit d) is a CO₂ and H₂O drier followed by a nitrogen wash.
21. System according to embodiment 17 wherein the reforming unit b) comprises a tubular or steam reformer followed by an autothermal reformer and the CO₂ removal unit d) is a PSA.
22. System according to embodiment 17, wherein the reforming unit b) comprises a tubular or steam reformer followed by an air blown secondary reformer and the CO₂ removal unit d) is a methanation unit.
23. System according to any one of embodiments 14 to 22 wherein the shift unit c) comprises a high temperature (HT) reactor or a medium temperature (MT) reactor or a low temperature (LT) reactor or any combination of at least two of these.
24. System according to embodiment 23 wherein two of i) HT reactor; ii) MT reactor; and/or iii) LT reactor are combined in series.
25. System according to any one of embodiments 14 to 24, wherein the fuel systems g) supply fuel to tubular reformers and/or fired heaters and/or auxiliary boilers and/or gas turbines.
26. System according embodiment 25, wherein the fuel systems g) comprise one or more burners.
27. Use of CO₂ obtained in step d) of embodiment 1 for CO₂ storage.
28. Use of CO₂ obtained in step d) of embodiment 1 to produce chemicals.
29. Use of CO₂ according to embodiment 28, wherein CO₂ obtained in step d) is used to produce urea.

1. A process for producing ammonia comprising the steps of:
a) removing sulphur and other contaminants from a hydrocarbon feed;
b) reforming the hydrocarbon stream from step a) and obtaining synthesis gas comprising CO, CO₂, H₂, H₂O and CH₄;
c) sending the gas from step b) through a shift reaction step reducing the CO content;
d) sending the gas from step c) to a CO₂ removal step where it is split in at least 2 streams: a CO₂ rich stream; and a hydrogen rich stream;
e) sending the hydrogen rich stream from step d) through:
i) hydrogen purification and nitrogen wash, where H₂O, CO, CO₂, CH₄ are removed in an off-gas stream and N₂ is added to obtain a synthesis gas stream comprising N₂ and H₂; or
ii) a PSA, resulting in a hydrogen stream containing more than 99.5% hydrogen to which nitrogen is added to obtain a synthesis gas stream comprising N₂ and H₂ and an off-gas stream; or
iii) methanation step, converting the CO and CO₂ together with H₂ into CH₄ and H₂O, to obtain a synthesis gas stream, N₂, H₂ and inerts comprising CH₄;
f) sending a part of the synthesis gas stream from step e) through an ammonia synthesis section, where it is converted to NH₃ and another part of the synthesis gas stream is sent to the fuel systems,
wherein at least part of the off-gas removed in step e) i) and e) ii) or at least part of recovered CH₄ stemming from synthesis gas in step e) iii) are compressed and sent to step a) or b).

2. The process according to claim 1, wherein in step d) the gas from step c) is sent to a CO₂ removal step where it is split in at least 3 streams: a CO₂ rich stream, a flash gas and a hydrogen rich stream, wherein the flash gas is compressed together with streams and sent to step a) or b).

3. The process according to claim 1, wherein a hydrocarbon fuel, flash gas from step d), off-gas from step e) and part of the synthesis gas streams from step e) are either premixed or fed separately to the fuel systems g).

4. The process according to claim 1, comprising an adiabatic pre-reforming step b₀) of the hydrocarbon stream from step a), before step b), wherein a synthesis gas comprising CH₄, CO, CO₂, H₂ and H₂O is obtained.

5. The process according to claim 1, wherein the amount of air to the air blown secondary reformer is adjusted to obtain a specific ratio of N₂ and H₂ between 1 to 2.5 and 1 to 3.5, in the stream from the methanation reactor.

6. The process according to claim 5, wherein the stream obtained from step e) comprises N₂ and H₂ in a ratio of 1 to 3.0.

7. A system for producing ammonia according to the process in claim 1, comprising:
a) a desulfurization unit;
b) a reforming unit;
c) a shift unit
d) a CO₂ removal unit;
e) a nitrogen washing unit or a pressure swing adsorption unit or a methanation unit,
f) an ammonia synthesis section; and
g) fuel systems,
wherein streams are directed to fuel systems g) and wherein streams are directed to desulfurization unit a) and/or to reforming unit b).

8. The system for producing ammonia according to claim 7, wherein the carbon content in the combined flue gases from the fuel systems g) is less than 5% of the combined carbon content in the hydrocarbon feed and the hydrocarbon fuel.

9. The system according to claim 7, wherein a further pre-reforming unit b₀) is upstream to the reforming unit b).

10. The system according to claim 7, wherein the reforming unit b) comprises an autothermal reformer or a tubular reformer followed by an autothermal reformer or a tubular reformer followed by an air blown secondary reformer.

11. The system according to claim 7, wherein the shift unit c) comprises a high temperature reactor or a medium temperature reactor or a low temperature reactor or any combination of at least two of these.

12. The system according to claim 7, wherein the fuel systems g) comprise tubular reformers, fired heaters, auxiliary boilers and gas turbines.

13. The system according claim 12, wherein the fuel systems g) comprise one or more burners.

14. A method comprising using the CO₂ obtained in step d) of claim 1 for CO₂ storage.

15. A method comprising using the CO₂ obtained in step d) of claim 1 to produce chemicals.
